(19) United States
(12) Patent Application Publication
(10) Pub. No.: US 2025/0174675 A1
(43) Pub. Date: May 29, 2025

(54) MEMBRANE FOR ELECTROCHEMICAL DEVICES

(71) Applicant: GM GLOBAL TECHNOLOGY OPERATIONS LLC, Detroit, MI (US)

(72) Inventors: Ruichun Jiang, Troy, MI (US); Swaminatha P. Kumaraguru, Rochester Hills, MI (US)

(73) Assignee: GM GLOBAL TECHNOLOGY OPERATIONS LLC, Detroit, MI (US)

(21) Appl. No.: 18/520,994

(22) Filed: Nov. 28, 2023

(51) Int. Cl. H01M 4/92; H01M 8/10; H01M 8/1004

(52) U.S. Cl. CPC H01M 4/926; H01M 8/1004; H01M 2008/1095; H01M 2250/20

(57) ABSTRACT

A membrane electrode assembly includes an anode, a cathode located adjacent to a cathode gas diffusion layer, and a proton exchange membrane (PEM) separating the anode from the cathode. The PEM includes at least one gas recombination layer, at least one an ionomer layer, and reinforcement layers. Each of the reinforcement layers include a pair of opposing surfaces with one of the at least one gas recombination layer or the at least one ionomer layer located adjacent to each of the pair of opposing surfaces.

### INTRODUCTION

The present disclosure relates generally to electrochemical systems, such as fuel cells for converting hydrogen-rich fuels into electricity or electrolyzers for converting water into hydrogen and oxygen. More specifically, aspects of this disclosure relate to a membrane electrode assembly for electrochemical systems.

An electrolyzer is an electrochemical device that converts water into hydrogen and oxygen using the process of electrolysis. Electrolyzers are commonly used to produce hydrogen. Hydrogen is used in many industrial applications, such as, for example, ammonia production. Electrolyzers may be used for localized hydrogen production, for example as fuel for vehicles equipped with hydrogen fuel cells. Electrolyzers may also be used to store energy from dynamic electrical sources, such as wind turbines and solar cells.

Hybrid-electric and full-electric vehicles employ a rechargeable energy storage system, such as a high voltage, high energy density electric vehicle battery (EVB) system or fuel cell system (FCS), to supply the requisite electricity for operating the vehicle powertrain's electric traction motor(s). As per the latter, a fuel cell is an electrochemical device generally composed of an anode electrode that receives a supply of hydrogen (H₂), a cathode electrode that receives an oxidizing agent (O₂), and an electrolyte barrier interposed between the anode and cathode electrodes. An electrochemical reaction is induced to oxidize hydrogen molecules at the anode side of the FCS—hydrogen gas is catalytically split in an oxidation half-cell reaction—to generate free electrons (−) and free protons (H+). The free hydrogen protons pass through the electrolyte barrier to the cathode side of the cell, where these protons react with oxygen and electrons in the cathode to form various stack by-products, usually water and heat. Free electrons from the anode, however, are prevented from passing through the electrolyte; these electrons are redirected to a load, such as a vehicle's traction motors and accessories, before being received at the cathode.

### SUMMARY

Disclosed herein is a membrane electrode assembly. The assembly includes an anode, a cathode located adjacent to a cathode gas diffusion layer, and a proton exchange membrane (PEM) separating the anode from the cathode. The PEM includes at least one gas recombination layer, at least one an ionomer layer, and reinforcement layers. Each of the reinforcement layers include a pair of opposing surfaces with one of the at least one gas recombination layer or the at least one ionomer layer located adjacent to each of the pair of opposing surfaces.

Another aspect of the disclosure may include an anode gas diffusion layer located adjacent to the anode.

Another aspect of the disclosure may include a porous transport layer located adjacent to the anode and on an opposite side of the anode from the PEM.

Another aspect of the disclosure may be where one of the reinforcement layers separates the at least one ionomer layer from the at least one gas recombination layer.

Another aspect of the disclosure may be where the reinforcement layers is comprised of at least one of an ionomer imbibed woven matrix material or an ionomer imbibed non-woven matrix material.

Another aspect of the disclosure may be where a thickness, matrix, and material composition for each of the reinforcement layers varies.

Another aspect of the disclosure may be where a thickness, matrix, and material composition for each of the reinforcement layers is the same.

Another aspect of the disclosure may be where at least one of the reinforcement layers is comprised of an expanded polytetrafluoroethylene (ePTFE).

Another aspect of the disclosure may be where the at least one gas recombination layer includes an ionomer with at least one gas recombination catalyst.

Another aspect of the disclosure may be where wherein the at least one gas recombination layer includes multiple gas recombination layers having a thickness, uniformity, and composition for each of the gas recombination layers that is varied.

Another aspect of the disclosure may be where the at least one gas recombination layer includes gas recombination layers having a thickness, uniformity, and composition for each of the gas recombination layers that is the same.

Another aspect of the disclosure may be where the at least one gas recombination catalyst includes at least one of platinum or palladium and the at least one recombination catalyst is supported by at least one of C, SiO2, TiO2, CeO2, Nb2O5, or IrOx.

Another aspect of the disclosure may be where the at least one gas recombination catalyst is distributed uniformly in at least one of the gas recombination layers.

Another aspect of the disclosure may be where the at least one gas recombination catalyst is distributed non-uniformly in the at least one gas recombination layers.

Another aspect of the disclosure may be where the at least one gas recombination catalyst is distributed as at least one of a particle, fiber, or flake.

Disclosed herein is a proton exchange membrane. The membrane includes at least one gas recombination layer, at least one an ionomer layer, and reinforcement layers. Each of the reinforcement layers include a pair of opposing surfaces with one of the at least one gas recombination layer or the at least one ionomer layer located adjacent to each of the pair of opposing surfaces.

Disclosed herein is a vehicle. The vehicle includes a vehicle body, wheels supporting the vehicle body, an electric motor configured to drive the wheels, and a battery configured to provide electrical power to the electric motor. The vehicle also includes a fuel cell configured to provide power to at least one of the battery or the electric motor. The fuel cell includes an anode, a cathode located adjacent to a cathode gas diffusion layer, and a proton exchange membrane (PEM) separating the anode from the cathode. The PEM includes at least one gas recombination layer, at least one an ionomer layer, and reinforcement layers. Each of the reinforcement layers include a pair of opposing surfaces with one of the at least one gas recombination layer or the at least one ionomer layer located adjacent to each of the pair of opposing surfaces.

### BRIEF DESCRIPTION OF THE DRAWINGS

FIG. 1 is an elevated, perspective-view illustration of a representative motor vehicle with an inset schematic illustration of a rechargeable energy storage system containing a traction battery pack and a fuel cell system for operating the electric motor(s) of an electrified powertrain according to aspects of the disclosed concepts.

FIG. 2 is a schematic view of an electrolysis system, according to one or more embodiments of the disclosure.

FIG. 3 is a cross-sectional view of an example cell stack in an electrolyzer of the electrolysis system of FIG. 2.

FIG. 4 illustrates an example membrane electrode assembly for use in the electrolysis system of FIG. 2.

FIG. 5 illustrates an example proton exchange membrane for use in either the fuel cell system of FIG. 1 or the electrolysis system of FIG. 2.

FIG. 6 illustrates another example proton exchange membrane for use in either the fuel cell system of FIG. 1 or the electrolysis system of FIG. 2.

FIG. 7 illustrates yet another example proton exchange membrane for use in either the fuel cell system of FIG. 1 or the electrolysis system of FIG. 2.

FIG. 8 illustrates a further example proton exchange membrane for use in either the fuel cell system of FIG. 1 or the electrolysis system of FIG. 2.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

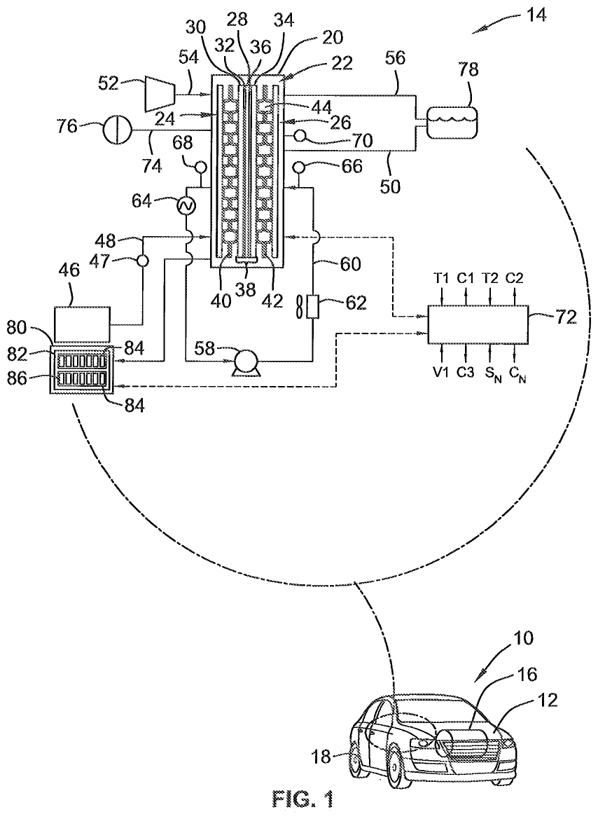

Referring now to the drawings, wherein like reference numbers refer to like features throughout the several views, there is shown in FIG. 1 a representative automobile, which is designated generally at 10 and portrayed herein for purposes of discussion as a sedan-style, fuel cell electric vehicle (FCEV). The illustrated automobile 10—also referred to herein as “motor vehicle” or “vehicle” for short—is merely an exemplary application with which novel aspects of this disclosure may be practiced. In the same vein, incorporation of the present concepts into a full-electric powertrain should be appreciated as a non-limiting implementation of disclosed features. As such, it will be understood that aspects and features of this disclosure may be applied to other powertrain architectures, utilized for a variety of different fuel cell system configurations, and incorporated into any logically relevant type of vehicle. Moreover, select components of the motor vehicles, FCS, and manufacturing systems are shown and described in additional detail herein. Nevertheless, the vehicles and systems discussed below may include numerous additional and alternative features, and other available peripheral components, for carrying out the various methods and functions of this disclosure.

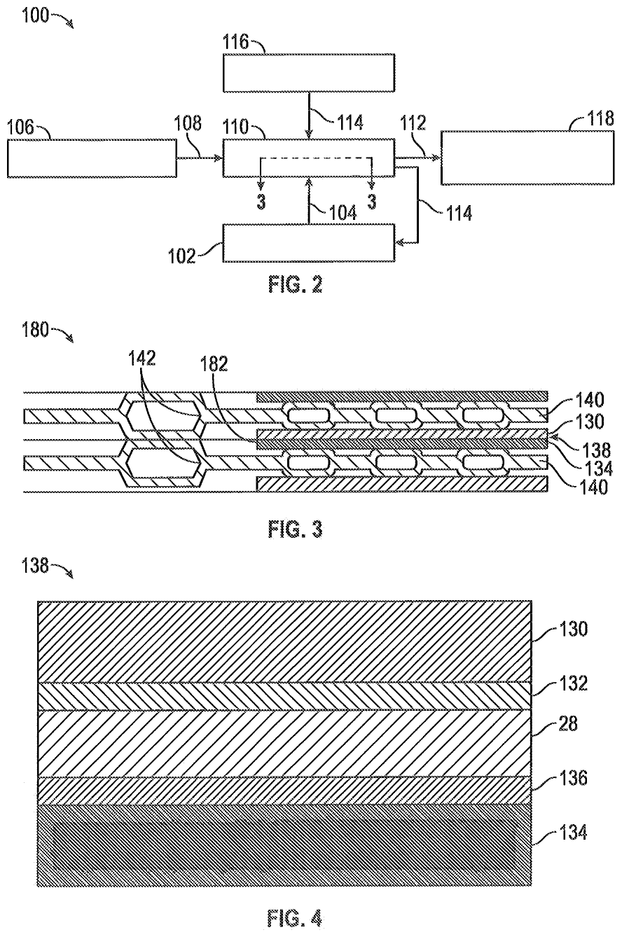

Packaged within a vehicle body 12 defining a passenger compartment of an automobile 10 is a representative fuel cell system 14 for powering a prime mover, such as electric motor generator unit (MGU) 16, that is operable for driving a combination of the vehicle's road wheels 18. An electrochemical system, such as a proton exchange membrane fuel cell system 14 of FIG. 1, is equipped with one or more fuel cell stacks 20, each of which is composed of multiple fuel cells 22 of the PEM type that are stacked and connected in electrical series or parallel with one another. In the illustrated architecture, each fuel cell 22 is a multi-layer construction with an anode side 24 and a cathode side 26 that are separated by a proton-conductive semipermeable polymer membrane 28. An anode gas diffusion electrode (GDE) layer 30 is provided on the anode side 24 of the PEMFC 22 with an anode catalyst layer 32 mounted onto the GDE layer 30 or interposed between and operatively connecting the membrane 28 and corresponding GDE layer 30. Juxtaposed in opposing spaced relation to the anode layers 30 and 32 is a cathode gas diffusion electrode (GDE) layer 34, which is provided on the cathode side 26 of the PEMFC 22. A cathode catalyst layer 36 is mounted onto the GDE layer 34 or interposed between and operatively connects the membrane 28 and corresponding GDE layer 34. The two GDE layers 30 and 34, two catalyst layers 32 and 36, and optional subgaskets (see FIG. 2 below) cooperate with the membrane 28 to define, in whole or in part, a membrane electrode assembly (MEA) 38.

The gas diffusion layers 30 and 34 may be porous constructions that provide for fluid inlet transport to and fluid exhaust transport from the MEA 38. An anode flow field plate 40 (with optional bipolar plate) is provided on the anode side 24 in abutting relation to the anode GDE layer 30. In the same vein, a cathode flow field plate 42 (with optional bipolar plate) is provided on the cathode side 26 in abutting relation to the cathode GDE layer 34. Coolant flow channels 44 traverse each of the plates 40 and 42 to allow cooling fluid to flow through the fuel cell 22. Fluid inlet ports and headers direct a hydrogen-rich fuel and an oxidizing agent to respective passages in the anode and cathode flow field plates 40, 42. A central active region of the anode's flow field plate 40 that faces the proton-conductive membrane 28 may be fabricated with an anode flow field composed of serpentine flow channels for distributing hydrogen over an opposing face of the GDE layer 30 and membrane 28. The MEA 38 and flow field plates 40, 42 may be stacked together between current collector plates and monopolar end plates (not shown). The fuel cell system 14 may also employ anode recirculation where an anode recirculation gas is fed from an exhaust manifold or headers through an anode recirculation line for recycling hydrogen back to the anode side 24 input to conserve hydrogen gas in the stack 20.

Hydrogen (H₂) inlet flow—be it gaseous, concentrated, entrained, or otherwise—is transmitted from a hydrogen source, such as fuel storage tank 46, to the anode side 24 of the fuel cell stack 20 via a fluid injector 47 coupled to a (first) fluid intake conduit or hose 48. Anode exhaust exits the stack 20 via a (first) fluid exhaust conduit or hose 50. Also shown on the inlet (lefthand) side of the stack 20 is a compressor or pump 52 that provides a cathode inlet flow, such as ambient air and/or concentrated gaseous oxygen (O₂), via a (second) fluid intake line or manifold 54 to the cathode side 26 of the stack 20. Cathode exhaust is output from the stack 20 via a (second) fluid exhaust conduit or manifold 56. Flow control valves, flow restrictions, filters, and other available devices for regulating fluid flow can be implemented by the PEMFC system 14 of FIG. 1. Electricity generated by the fuel cell stack(s) 20 and output by the fuel cell system 14 may be transmitted for storage to an in-vehicle traction battery pack 82 within a rechargeable energy storage system (RESS) 80.

Fuel cell system 14 of FIG. 1 may also include a thermal sub-system operable for controlling the temperature of the fuel cell stack 20, e.g., during preconditioning, break-in, and post-conditioning. According to the illustrated example, a cooling pump 58 pumps a coolant fluid through a coolant loop 60 to the fuel cell stack 20 and into the coolant channels 44 in each cell 22. A radiator 62 and an optional heater 64 fluidly coupled in the coolant loop 60 are used to maintain the stack 20 at a desired operating temperature. This thermal sub-system may be equipped with various sensing devices for monitoring regular system operation as well as progress of fuel cell conditioning and break-in. For instance, an inlet (first) temperature sensor 66 monitors a temperature value of the coolant at a coolant inlet to the fuel cell stack 20, and an outlet (second) temperature sensor 68 measures a temperature value of the coolant at a coolant outlet of the stack 20. An electrical connector or cable 74 connects the fuel cell stack 20 to an electric power load 76, which may be employed to draw current from each cell 22 in the stack 20. A voltage/current sensor 70 is operable to measure, monitor, or otherwise detect fuel cell voltage and/or current across the fuel cells 22 in the stack 20.

Programmable electronic control unit (ECU) 72 helps to control operation of the fuel cell system 14. As an example, ECU 72 receives one or more temperature signals T1 from one or more of the temperature sensors 66, 68 that indicate the temperature of the fuel cell stack 20; ECU 72 may be programmed to responsively issue one or more command signals C1 to modulate operation of the stack 20. ECU 72 of FIG. 1 also receives one or more voltage signals V1 from the voltage sensor/current 70; ECU 72 may be programmed to responsively issue one or more command signals C2 to modulate operation of a hydrogen source (e.g., fuel storage tank 46) and/or compressor/pump 52 to thereby regulate the electrical output of the stack 20. ECU 72 of FIG. 1 is also shown receiving one or more coolant temperature signals T2 from sensors 66 and/or 68; ECU 72 may be programmed to responsively issue one or more command signals C3 to modulate operation of the fuel cell's thermal subsystem. Additional sensor signals SN may be received by the ECU 72 and additional control commands CN may concomitantly be issued from the ECU 72, e.g., to control any other sub-system or component illustrated and/or described herein. The ECU 72 may emit a command signal to transmit evolved hydrogen and liquid H₂O from the cathode side 26 through fluid exhaust conduit 56 to a water separator 78 (FIG. 1) where hydrogen and water from the cathode are combined with depleted hydrogen exhausted from the anode through fluid exhaust conduit/hose 50.

With continuing reference to FIG. 1, the traction battery pack 82 contains an array of rechargeable lithium-class (secondary) battery modules 84. Aspects of the disclosed concepts may be similarly applicable to other electric storage unit architectures, including those employing nickel metal hydride (NiMH) batteries, lead acid batteries, lithium metal batteries, or other applicable type of rechargeable electric vehicle battery (EVB). Each battery module 84 may include a stack or cluster of electrochemical battery cells, such as pouch-type lithium ion (Li-ion) or Li-ion polymer battery cells 86. An individual battery module 84, for example, may be typified by a grouping of 10-80 Li-ion battery cells that are stacked in side-by-side facing relation with one another and connected in parallel or series for storing and supplying electrical energy. While described as silicon-based, Li-ion “pouch cell” batteries, the cells 86 may be adapted to other constructions, including cylindrical and prismatic constructions.

FIG. 2 is a schematic top view of a portion of an electrolysis system 100. In the illustrated example, the electrolysis system 100 includes an electrolyzer, such as a proton exchange membrane (PEM) electrolyzer. In one example, the PEM electrolyzer includes a cell block formed of a plurality of stacked cells (e.g., in series) in which each cell includes various components including various membrane electrode assembly (MEA) components. The MEA components include a solid polymer membrane (i.e., proton exchange membrane or PEM) that is disposed between an anode and a cathode. The MEA components that make up the cathode include a catalyst layer disposed adjacent to a gas diffusion layer (GDL). Likewise, the MEA components that make up the anode include a catalyst layer disposed adjacent to a porous transport layer (PTL). The PEM selectively allows positively charged hydrogen ions to pass through the membrane between the anode and the cathode as part of the electrolysis process to convert water into hydrogen and oxygen.

As illustrated in FIG. 2, the electrolysis system 100 includes a water source 102 that is in fluid communication with an electrolyzer stack 110 via line 104 to provide a water feedstock to the electrolyzer stack 110. Any unused, remaining and/or by-product water is returned from the electrolyzer stack 110 to the water source 102 via a recycle streamline 114. Additionally, a power source 106 and power electronics 116 are in communication with the electrolyzer stack 110 via lines 108 and 114, respectively. In one or more embodiments of the disclosure, a hydrogen storage device 118 is in fluid communication with the electrolyzer stack 110 via line 112 to receive hydrogen product that is produced during electrolysis in the electrolyzer stack 110, as will be discussed in further detail below.

As illustrated, the electrolyzer stack 110 receives electricity (i.e., an electrical current) from the power source 106 via line 108 and water from the water source 102 via line 104. The electrolyzer stack 110 converts water from the water source 102 into hydrogen and oxygen via electrolysis using electricity supplied by the power source 106. Hydrogen gas is output from the electrolyzer stack 110 as a hydrogen product stream and is advanced to the hydrogen storage device 118 via line 112.

During operation of the electrolysis system 100, the power source 106 supplies direct current to the electrolyzer stack 110. Examples of power sources include, but are not limited to, batteries, solar cells, DC generators, wind turbines, hydropower plants, and/or the like.

The power electronics 116 are in communication with the electrolyzer stack 110 and are configured to control the operation of the electrolyzer stack 110. For example, the power electronics 116 may control the amount of voltage and current supplied to the electrolyzer stack 110 from the power source 106.

FIG. 3 illustrates a cross-sectional view of the electrolyzer stack 110 taken along line 3-3 of FIG. 2. In one or more embodiments of the disclosure, the electrolyzer stack 110 includes a cell block 180 formed from multiple cells 182.

The plurality of cells 182 includes a plurality of seals 142 and a plurality of separator plates 140. The cells in the plurality of cells 182 are stacked in the cell block 180 and are electrically connected in series. Each cell in the plurality of cells 182 includes various components, including membrane electrode assembly (MEA) 138, a pair of separator plates 140, and a pair of seals 142.

The pair of separator plates (from the plurality of separator plates 140) contains flow channels that interface with the MEA 138 and that allow the flow of fluids (e.g., water, hydrogen gas, and oxygen gas) to or from the MEA 138. Each separator plate 140 is electrically conductive and facilitates the transport of electrons to assist in establishing the electrical circuit of the electrolysis process.

As shown in FIG. 4, the MEA 138 includes a solid polymer membrane (i.e., proton exchange membrane 28 or PEM), an anode 132 (i.e., anode-catalyst layer), and a cathode 136 (i.e., cathode-catalyst layer). The PEM 28 is disposed between the anode-catalyst layer 132 and the cathode-catalyst layer 136. The cathode-catalyst layer 136 is disposed adjacent to a gas diffusion layer (GDL) 134. Likewise, the anode-catalyst layer 132 is disposed adjacent to a porous transport layer (PTL) 130. In the case of fuel cells, a GDL will be used in place of the PTL. The PEM 28 contains an active zone where the electrochemical reaction for the conversion of water to hydrogen via electrolysis occurs. The PEM 28 selectively allows positively charged hydrogen ions to pass through the membrane between the anode 132 and the cathode 136 as part of the electrolysis process to convert water into hydrogen and oxygen.

Each cell 182 is structured such that the MEA 138 is disposed between pairs of separator plates 140. The pair of seals (from the plurality of seals 142) prevent leakage of fluids (e.g., water, hydrogen gas, and oxygen gas) from the interface between the MEA 138 and the pair of separator plates 140. The pair of seals 142 defines an MEA perimeter. The MEA perimeter is an area where the fluids are confined prior to exiting the MEA 138 via the pair of separator plates 140.

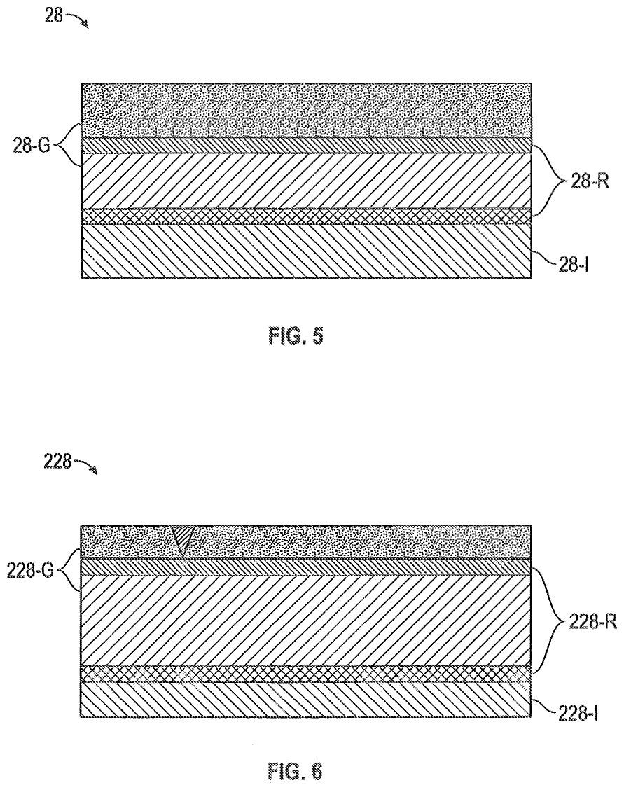

As shown in FIG. 5, the membrane 28 includes multiple gas recombination layers 28-G and multiple reinforcement layers 28-R. In the illustrated example, adjacent reinforcement layers 28-R are separated from each other by at least one of the gas recombination layers 28-G. An ionomer layer 28-I is located immediately adjacent to one of the plurality of reinforcement layers 28-R. One feature of the plurality of reinforcement layers 28-R is a reduction in the formation of cracks in the membrane 28.

At least one of the reinforcement layers 28-R separates the ionomer layer 28-I from the plurality of gas recombination layers 28-G. The reinforcement layers 28-R are comprised of at least one of an ionomer imbibed woven matrix material or an ionomer imbibed non-woven matrix material. In the illustrated example, a thickness of each of the plurality of reinforcement layers 28-R is the same with a matrix or composition being the same or varying between layers. At least one of the plurality of reinforcement layers can be comprised of an expanded polytetrafluoroethylene (ePTFE).

The gas recombination layers 28-G can include an ionomer with at least one gas recombination catalyst. The gas recombination catalyst can include at least one of platinum or palladium. The gas recombination catalyst is supported by a support structure that includes at least one of C, SiO2, TiO2, CeO2, Nb2O5, or IrOx. The gas recombination catalyst can be distributed uniformly or non-uniformly in at least one of the gas recombination layers. Furthermore, the gas recombination catalyst can be distributed as one of a particle, fiber, or flake in the gas recombination layer 28-G. The gas recombination layers 28-G can have loading of the gas recombination catalysts between about 0.1% to 99.9%. In another example, the gas recombination layers 28-G can have loading of the gas recombination catalysts between about 0.1% and 50%.

The gas recombination layers 28-G can also overlap with the reinforcement layers to the extent of 0 to 100%. In the illustrated example, a thickness of each of the gas recombination layers 28-G is the same with the uniformity or composition being the same or varying between layers. One feature of the gas recombination layers 28-G is a reduction in hydrogen or oxygen crossover through the membrane 28.

FIG. 6 illustrates yet another example membrane 228 similar to the membrane 28 except where shown in the drawings or described below. Similar or identical elements between the membrane 228 and the membrane 28 will include like numbering with the addition of a leading “2” added in FIG. 6. As shown in FIG. 6, gas recombination layers 228-G include varying thicknesses with the gas recombination layer 228-G between reinforcement layers 228-R being thicker than the gas recombination layer 228-G adjacent a perimeter of the membrane 228.

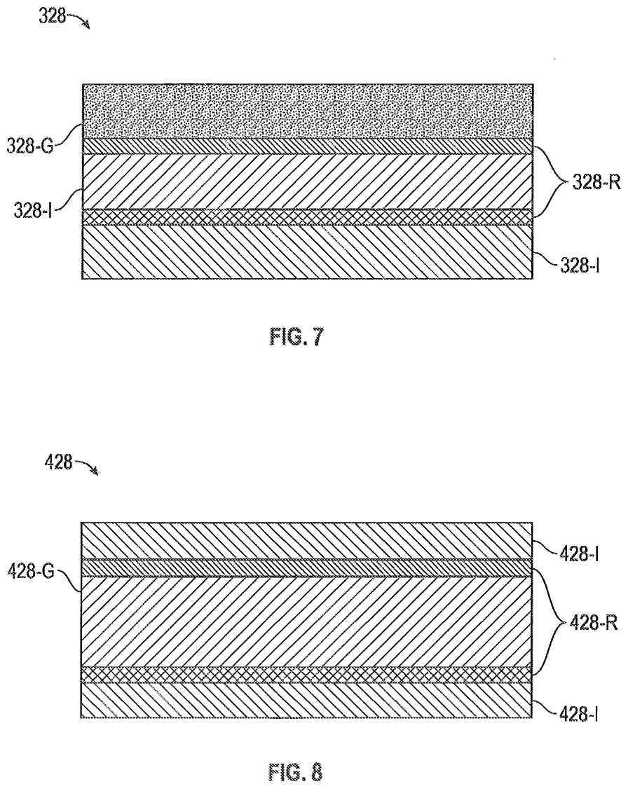

FIG. 7 illustrates yet another example membrane 328 similar to the membrane 28 except where shown in the drawings or described below. Similar or identical elements between the membrane 328 and the membrane 28 will include like numbering with the addition of a leading “3” added in FIG. 7. As shown in FIG. 7, an ionomer layer 328-I is located in the middle of the membrane 328 with a first reinforcement layer 328-R separating the ionomer layer in the middle from another ionomer layer 328-I on a first side and a second reinforcement layer 328-R separating the middle ionomer layer 328-I from a gas recombination layer 328-G on a second side.

FIG. 8 illustrates a further example membrane 428 similar to the membrane 28 except where shown in the drawings or described below. Similar or identical elements between the membrane 428 and the membrane 28 will include like numbering with the addition of a leading “4” added in FIG. 8. As shown in FIG. 8, a gas recombination layer 428-G is located in the middle of the membrane 428 and is surrounded by reinforcement layers 428-R. An ionomer layer 428-I is located adjacent to each of the reinforcement layers 428-R opposite from the gas recombination layer 428-G located between the reinforcement layers 428-R.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A membrane electrode assembly comprising:
an anode;
a cathode located adjacent to a cathode gas diffusion layer; and
a proton exchange membrane (PEM) separating the anode from the cathode; wherein the PEM includes:
at least one gas recombination layer;
at least one an ionomer layer; and
a plurality of reinforcement layers each having a pair of opposing surfaces with one of the at least one gas recombination layer or the at least one ionomer layer located adjacent to each of the pair of opposing surfaces.

2. The assembly of claim 1, including an anode gas diffusion layer located adjacent to the anode.

3. The assembly of claim 1, including a porous transport layer located adjacent to the anode and on an opposite side of the anode from the PEM.

4. The assembly of claim 1, wherein one of the plurality of reinforcement layers separates the at least one ionomer layer from the at least one gas recombination layer.

5. The assembly of claim 1, wherein the plurality of reinforcement layers is comprised of at least one of an ionomer imbibed woven matrix material or an ionomer imbibed non-woven matrix material.

6. The assembly of claim 5, wherein a thickness, matrix, and material composition for each of the plurality of reinforcement layers varies.

7. The assembly of claim 5, wherein a thickness, matrix, and material composition for each of the plurality of reinforcement layers is the same.

8. The assembly of claim 5, wherein at least one of the plurality of reinforcement layers is comprised of an expanded polytetrafluoroethylene (ePTFE).

9. The assembly of claim 1, wherein the at least one gas recombination layer includes an ionomer with at least one gas recombination catalyst.

10. The assembly of claim 9, wherein the at least one gas recombination layer includes a plurality of gas recombination layers having a thickness, uniformity, and composition for each of the plurality of gas recombination layers that is varied.

11. The assembly of claim 9, wherein the at least one gas recombination layer includes a plurality of gas recombination layers having a thickness, uniformity, and composition for each of the plurality of gas recombination layers that is the same.

12. The assembly of claim 9, wherein the at least one gas recombination catalyst includes at least one of platinum or palladium and the at least one recombination catalyst is supported by at least one of C, SiO2, TiO2, CeO2, Nb2O5, or IrOx.

13. The assembly of claim 9, wherein the at least one gas recombination catalyst is distributed uniformly in at least one of the plurality of gas recombination layers.

14. The assembly of claim 9, wherein the at least one gas recombination catalyst is distributed non-uniformly in the at least one recombination layer.

15. The assembly of claim 9, wherein the at least one gas recombination catalyst is distributed as at least one of a particle, fiber, or flake.

16. A proton exchange membrane comprising:
at least one gas recombination layer;
at least one an ionomer layer; and
a plurality of reinforcement layers each having a pair of opposing surfaces with one of the at least one gas recombination layer or the at least one ionomer layer located adjacent to each of the pair of opposing surfaces.

17. The proton exchange membrane of claim 16, wherein one of the plurality of reinforcement layers separates the at least one ionomer layer from the at least one gas recombination layer and at least one of the plurality of reinforcement layers is comprised of an expanded polytetrafluoroethylene (ePTFE).

18. The proton exchange membrane of claim 16, wherein the plurality of reinforcement layers is comprised of at least one of an ionomer imbibed woven matrix material or an ionomer imbibed non-woven matrix material.

19. The proton exchange membrane of claim 16, wherein the at least one gas recombination layer includes an ionomer with at least one of platinum or palladium and the at least one gas recombination catalyst is supported by at least one of C, SiO2, TiO2, CeO2, Nb2O5 or IrOx.

20. A vehicle comprising:
a vehicle body defining a passenger compartment;
a plurality of wheels supporting the vehicle body;
an electric motor configured to drive the plurality of wheels; and
a fuel cell configured to provide power to the electric motor to drive the plurality of wheels, the fuel cell comprising:
an anode;
a cathode located adjacent to a cathode gas diffusion layer; and
a proton exchange membrane (PEM) separating the anode from the cathode;
wherein the PEM includes:
at least one gas recombination layer;
at least one an ionomer layer; and
a plurality of reinforcement layers each having a pair of opposing surfaces with one of the at least one gas recombination layer or the at least one ionomer layer located adjacent to each of the pair of opposing surfaces.
